(19) United States
(12) Patent Application Publication
(10) Pub. No.: US 2009/0043552 A1
(43) Pub. Date: Feb. 12, 2009

(54) INTERACTIVE SIMULATION

(76) Inventors: William Michael Tomlinson, JR., Irvine, CA (US); Andrew William Torrance, Leawood, KS (US); Bryant Drew Jones Davey, Corona, CA (US)

Correspondence Address: MAXVALUEIP CONSULTING, 11204 ALBERMYRTLE ROAD, POTOMAC, MD, 20854, US

(21) Appl. No.: 12/189,770

(22) Filed: Aug. 11, 2008

Related U.S. Application Data
(60) Provisional application No. 60/954,864, filed on Aug. 9, 2007.

(51) Int. Cl. G06G 7/48

(52) U.S. Cl. 703/6

(57) ABSTRACT

Patent systems are often justified by assumptions that inventive activity will be spurred by the prospect of patent protection, leading to the accrual of greater societal benefits than would be possible under non-patent systems. One way to test this hypothesis is experimentally to simulate the behavior of inventors and licensees, in particular, and society, in general, under conditions approximating patent and non-patent systems. By measuring differences in a metric representing societal benefit, it is possible to make direct quantitative comparisons between such alternative systems. The simulation is simulating all parameters in the patent system, useful for economists, social scientists, IP professionals, students, attorneys, business people, and government planners, among others.

### RELATED APPLICATIONS

This application is a continuation of a U.S. provisional utility patent application, Ser. No. 60/954,864, filed Aug. 9, 2007, with common inventors and a similar title. The provisional application contains a computer program listing appendix, submitted electronically via EFS-web, as an ASCII text file, the content of which is herein incorporated by reference.

### BACKGROUND OF THE INVENTION

The present invention generally relates to an interactive simulation (patent or IP (intellectual properties)) system and, more specifically, to an interactive computer-based implementation of a patent system where any number of users may take part in the system at a given time.

As can be seen, there is a need for an interactive patent system that may test the behavior of real-world patent systems by simulating such systems under different conditions. There also is a need for a multi-user interactive patent system that may be incorporated into, for example, an online virtual world. The IP or patent professionals, PTO officials, attorneys, law students, licensing professionals, licensing executives, investors (VCs), business development executives, teachers, psychologists, social scientists, high school, college, graduate school, or professional school (e.g., law, business, policy, or medicine) students, economists, industrial planners, government officials or decision makers, Congress, and game enthusiasts, among others, may use this program/invention for their businesses or requirements.

### SUMMARY OF THE INVENTION

Patent systems are often justified by assumptions that inventive activity will be spurred by the prospect of patent protection, leading to the accrual of greater societal benefits than would be possible under non-patent systems. One way to test this hypothesis is to experimentally simulate the behavior of inventors and licensees, in particular, and society, in general, under conditions approximating patent and non-patent systems. By measuring differences in a metric representing societal benefit, it is possible to make direct quantitative comparisons between such alternative systems. A multi-user interactive simulation system (“PatentSim™”) may be used to test hypotheses (or obtain statistics and trend) of individual and societal benefits (and behavior) by varying incentives for such activities as invention, licensing, selling, infringement, and enforcement by creating a modified (e.g., simplified) model of the inventive process, and networking together multiple users so they can interact through this system.

PatentSim™ may use an abstract and cumulative model of potential innovations, a database of potential innovations, an interactive interface that allows users to invent these innovations, and a network over which users may interact with one another. Users can potentially cooperate or compete by recombining simpler inventions into more complex and powerful combination inventions. PatentSim™ may be used to test hypotheses regarding the benefits conferred on society, in general, and patent inventors, licensees, sellers, infringers, and enforcers, in particular, under patent and non-patent systems and other real or potential legal systems, for example, any IP system.

These and other features, aspects and advantages of the present invention will become better understood with reference to the following drawings, description and claims.

### BRIEF DESCRIPTION OF THE DRAWINGS

FIG. 1 is an interactive patent system simulation according to the present invention (a simplified example/ version of a screenshot);

FIG. 2 is an interactive patent system simulation according to the present invention;

FIG. 3 is an interactive patent system simulation according to the present invention;

FIG. 4 is an interactive patent system simulation according to the present invention;

FIG. 5 is an interactive patent system simulation according to the present invention;

FIG. 6 is an interactive patent system simulation according to the present invention;

FIG. 7 is an interactive patent system simulation according to the present invention; and

FIG. 8 is an interactive patent system simulation according to the present invention.

FIG. 9 is the overall system, as an example.

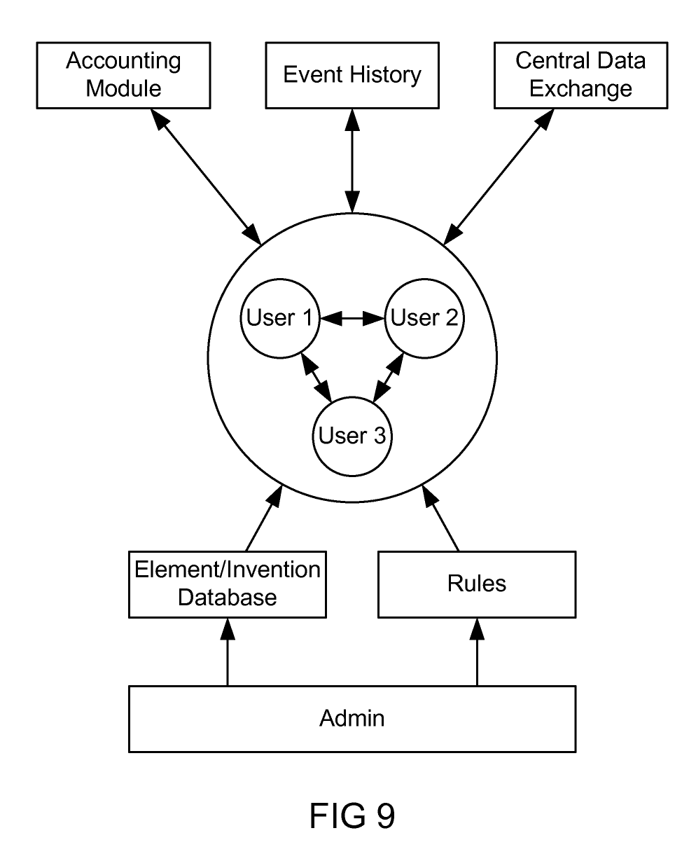

### DETAILED EMBODIMENTS OF THE INVENTION

The following description is not to be taken in a limiting sense, but is made merely for the purpose of illustrating the general principles of the invention (as examples and just different embodiments).

The term “interactive” when used to describe a patent system refers to a patent system in which a user of the system may make choices within the confines of the system to possibly change outcomes produced by the system. For example, an interactive patent system may have at least one user that can choose to patent an item, make an item, license a patent, sell a patent, enforce a patent and the like. Such an interactive patent system may be considered a “simulation” in that it may simulate a real-world patent system. The interactive patent system may be considered a “game” in that multiple users may access the same system and compete against each other to determine which user may have the best strategy in terms of choosing items to patent, sell, license, enforce, and the like. An interactive patent system according to the present invention may run automatically, replacing some or all of the human users with computational agents or other systems, thereby simulating, for example, in hours, what could take many years in a real-world patent system. Users of an interactive patent system according to the present invention may include a human user or users, an automated user or users (e.g., a computer or computers following a software algorithm or algorithms), or any mixture thereof.

The term “element” may be defined as an individual component that a user may make or patent, either individually or in combination with one or more other elements. Elements can be represented by any types of designators, such as letters, numbers, colors, shapes, symbols, sounds, patterns, and the like. Elements may be called components, tiles, blocks or the like, depending on the particular form of the element. For example, the string of letters ABCD could represent a unique invention comprised of two pieces of prior art, AB and CD, with a reason for combination, combined together.

The term “lobby” may be used to refer to a virtual location where players may gather before, during, or after a game. A lobby may permit players to see who is present and a lobby may permit conversations, or on-line chat amongst players. In one embodiment of the present invention, the lobby may be used prior to starting the game to determine whether all the appropriate players have joined the game before starting.

The term “interactive display” may be used to refer to a user interface in which the user may control some aspect of the simulation. In one embodiment of the present invention, the interactive display may be a computer screen where a user may be able to choose various items to complete a certain task (e.g., organize elements into an invention and choose to patent the invention). An interactive display may include one or several locations in which the user may interface.

The interactive patent system of the present invention may provide a game, a training tool, a business strategy tool and the like, based on various user-defined parameters, structures, and processes. These parameters, structures, and processes, as discussed in more details below, may mimic patent systems of particular countries, may deliberately be chosen to simulate alternatives to existing patent systems, or else, may be user-imagined patent system parameters, structures, and processes.

The interactive patent system of the present invention may also be useful as a tool to study individual reaction time and choices or the reaction time and choices of a large number of users. A database may be kept during the game to keep track of, for example, the time it takes for a user or users to decide on certain actions and which actions are decided upon. This database may be studied at the completion of the simulation, or even during the simulation, to help determine individual or group reaction to various events of the game. This can be incorporated along with the game theory, to study the choices of individuals and groups/subgroups. In addition, there could be a feedback loop in which the analysis of the database could dynamically alter the parameters, structures and processes of the system.

The users can have a bank account (or other types of value, score, points, credit, or currency) portable from one simulation to another, or just for one simulation. The accounting system and simulation can be incorporated in Second Life, or other single-user or multi-user games or virtual environments. One option is use of open source for the system, so that contributions come from the users' community or groups.

In addition to use in games, virtual environments, research tools and other simulations, this invention could also be utilized in real world contexts. For example, a real country could adopt a patent system in which the parameters, structures, and processes of the system are dynamically adjusted to achieve one or more specific benefits. For example, a country might cause the length of protection to be dynamically specified to offer greater or lesser protection in order to insure that the load on their patent examiners and the turn-around time were both maintained within reasonable levels, or they can gauge the effects of different IP-related variables on the economy and social benefits.

In one embodiment, PatentSim™ includes an option of making an invention “open source”. An open source invention could, optionally, be available for use by any user without restriction, could be patentable or unpatentable, and any invention incorporating such an open source invention could itself be patentable or unpatentable, and/or could be used by any user willing to agree to the terms of a license (e.g., a variation of the GNU General Public License (“GPL”) or Berkeley Software License (“BSD”).

PatentSim™ may use an abstract and cumulative model of potential innovations, a database of potential innovations, an interactive interface that allows users to invent these innovations and a network over which users may interact with one another. Users can potentially cooperate or compete by recombining simpler inventions into more complex and powerful combination inventions, in a setting such as stock market, E-Bay/auction, or idea laboratory. They may also license, buy, lease, rent, and sell patents to each other. The system may be implemented using an online server and the Ruby on Rails web application framework or via many different programming languages.

The license of patent could be geographical-based or time-based, with expiration, which requires a clock to show the time to the user, plus a map to show which region in the world it is licensed for. The license can include other information, such as specific application, field-of-use, or purpose. For example, a patented encryption method can be used for video content, but not text. Thus, the menu has different options, for the licensing, to carve out the slices and pieces (limitation parameters), for the license intended, which can limit the scope of license, for a lower price/fee. The other option is being exclusive or non-exclusive license, which also shows overlap of the coverage, and can affect the competing products and companies.

One embodiment is the patent pooling option, wherein the number of patents in a jurisdiction (e.g. a US patent) will be counted, and the ratio of the number from contributors of the pool to the total number determines the percentage. In another option, patent applications have lower weights, e.g. a fraction of 1 or 100 percent. In another embodiment, a broad patent has more weight, more than 1 (normalized value), than a narrow or normal patent. Thus, a separate value tracks the broadness or scope of the claims or patents. Another option is for the jurisdiction that uses the product, or the jurisdiction that manufactures the product.

Another option is crossing between different jurisdictions for patents in different areas. It may infringe patents in 2 or more countries. If a product infringes 2 patents by 2 owners, they may need both licenses. For example, one may manufacture a car, which needs license for headlights and tires, from their respective patent owners.

Another option is assigning a patent to another entity. Another option is that the system does not let the user go negative in the budget. For example, if the user cannot pay the maintenance fee for the patent during the term of the patent, as shown by the clock/calendar on the screen, the patent becomes public domain, and goes to the list of available technologies, for free.

Another option is assigning or selling a patent to another entity, such as a third company or public, to devastate the competition. Another option is sublicensing of an original patent, or cross-licensing between two or more companies, wherein money may or may not exchange hands, depending on the absolute values and relative values of the patents.

Another option is prosecution modeling or appeal (procedures at different stages) modeling of the system, so that attorney cost, time axis, and different outcomes for the appeal/various papers and actions are parameters that can be adjusted, studied, and simulated. The menu has an option table for the fees, quality of the work, papers submitted. To make it more realistic, one can add an element of time, such as deadline, to be met, extended, for a fee, or otherwise, gets abandoned.

Another option is double-patenting rejection, determined by any logical relationships between the elements of the patent or subcomponents, e.g. ABCD vs. ABCDE. The rejection or infringement analysis can also be defined the same way, for the same logic, grammar, or format, e.g. ABCD vs. ABCDE, between products and patents. The interference and other issues can be added with the help of clock, for the time stamp, for hidden or non-public actions, e.g. date of invention, or date of filing. Various rejections or validity analysis can be added for public use situations or other types of merit analysis, e.g. 102 (b) type art rejections, based on the parameters of time available for comparisons.

According to one embodiment of the present invention, an interactive simulation of the patent system may be created with the ability to vary parameters for any of its constituent components. This variability may allow the system to be used to test various combinations of parameters to measure their effectiveness and results, and to optimize it for various applications.

The interactive patent system of the present invention may be useful in a number of situations. For example, the interactive patent system of the present invention may be useful to test the behavior of any real-world patent system or similar IP protection system by simulating under different conditions. The interactive patent system is capable of simulating any patent practice, rule, regulation, statutory provision, or constitutional provision, or any combination thereof.

Additionally, the interactive patent system of the present invention may be useful to implement a legal system for an online virtual world such as Second Life. Linden Lab (maker of Second Life) and the makers of other online virtual worlds (e.g., World of Warcraft, There.com, etc.) may incorporate such a virtual patent system into their virtual worlds. In a similar way to the role that the patent system has in encouraging innovation in the real world, Linden Lab could implement a patent system, as our current invention, to encourage innovation to occur in Second Life, thus, enhancing the quality and richness of the experience for their users. Video game companies, especially Massively Multiplayer Online Game (MMOG) makers may also be interested in organizing a patent system, such as the interactive patent system of the present invention, into their online games. As with virtual worlds, online games might also be improved by including models of patent systems in which innovative practices or moves could be patented and their inventors rewarded. For example, a particular action of the user, such as a particular keystroke, joystick movement, button depression, eye movement, vocal command, or other means of control (or combinations thereof), may be considered novel by the game. This action may be associated with a certain power or characteristic that the player would then possess as a result of making such a discovery. Similarly, novel actions taken in a virtual world (e.g., coloring one's hair red) could result in that character having exclusive rights in such an action, with the associated benefit therefrom. This would lead to an enhanced rate of innovation in many kinds of video games.

Moreover, the interactive patent system of the present invention may be useful to allow companies and individuals to optimize their patent strategies. Companies wishing to optimize their patent strategies, such as IBM, Google, Cisco, or Microsoft may find benefit in a patent simulation, such as the interactive patent system of the present invention. Companies could test different potential patenting strategies by varying parameters allowed by the patent game in order to determine which particular strategies best suited the goals and potentials of the company. This could confer a strategic advantage on companies that are heavily reliant on having a successful patent strategy. For example, a company could use a patent simulation to compare its current research and development, patenting, patent licensing and selling, and enforcement practices with alternative practices, to determine which set of practices yields a more desirable result (e.g., enhanced profits, increased efficiency, higher levels of innovation, or decreased costs). Simulations could be carried out by groups of humans (e.g., managers, engineers, scientists) or be entirely automated. In addition, those interested in designing patent systems with improved or optimal functioning could use a patent simulation to vary parameters, compare results between different combinations of parameters, and then choose patent systems that have those parameters that yield a desired patent system. Again, simulations could be carried out by groups of humans (e.g., managers, engineers, scientists) or be entirely automated.

Thus, one can change the laws, rules, fee structures, prices, hourly rates (e.g. attorney's cost), and other economic factors (such as interest rates and inflation rates) to get the relationship between patents, products, real value, current value, future value, and licensing terms, to estimate which system works for what country or under what economic and trading culture or conditions.

According to one aspect of the present invention, an interactive patent system could include the following, for different embodiments:

A simple, but challenging, computer game in which certain combinations of keystrokes confer an advantage to a player employing such keystrokes. For example, keystroke combinations could increase a player's speed, jumping ability, imperviousness to attack, or shooting capacity, depending on the format of the game.

A means of detecting whether and when a particular player has discovered an advantageous keystroke combination.

A means of locking out or enabling specific players from employing a keystroke combination “invented” (discovered) by another player.

A means of keeping track of “points” (or some other measurement) that denote success in the game. For example, one might keep track of (1) points accrued by each individual player and (2) total aggregate points accrued by society (that is, the sum total of all players). One might also keep track of precisely when each point is scored, the rate at which points are scored, and correlations and causal relationships between such parameters. That would show the effect of patent on individuals, society, and economy, for example. Other parameters can also be defined to measure the total or average output of the society, normalized to the time zero, for initial condition, such as a base year or date.

A means of simultaneously pausing the game for all players.

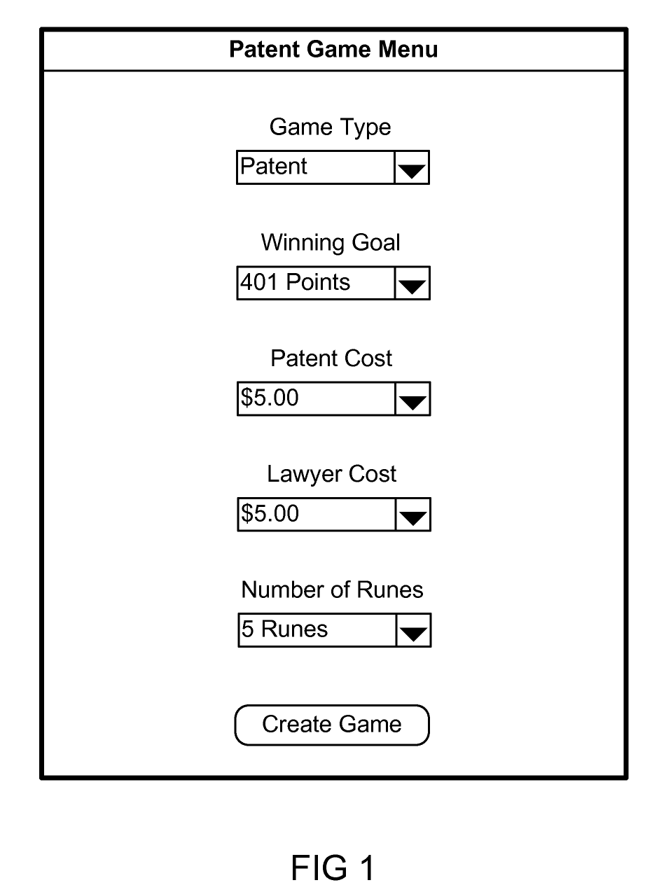

This aspect of the present invention, as summarized above and described in more details below, relates to one of many examples of how the interactive system of the present invention may be used. Additional embodiments of the present invention are further described in more details below. For example, additional embodiments of the present invention are described below with reference to FIGS. 1-8.

Note that in FIG. 1, we could simply use “elements” instead of “Runes”. In the “Design” box, the “components” in “Drag your components inside there” are synonymous with “elements” as well.

A help section can be added to help navigate the new users at different steps, using computer messages, or live help, from a central paying location, or from peer experts, helping novice users.

The game can be stopped for a break. It also can be saved in one embodiment, or reversed to a position/condition saved before. The saved portions can be coordinated together for different users to be consistent with each other. In case of inconsistencies, there is a mechanism to resolve the contradictory parameters between multiple users, so that the overall rules make sense, and the game does not hang up or crash.

The patent version of the game could be played as follows. Cohorts of players (e.g., groups of ten) use identical computer terminals with screens and keyboards. Players are informed that the goal of the game is to earn the highest score, that certain combinations of keystrokes can improve their performance in the game, allowing them an advantage in earning the highest score, and that the first player to discover a keystroke combination will have the option of using it exclusively for him/herself or giving others permission to use it in return for payment of points from other players to the “inventor”.

The game could run for a specified period of time (e.g., 30 minutes). When a player discovers a keystroke combination, the “inventor” is given the option (with radio buttons and clear explanations, an automatic time limit, and a default choice should the player fail to make a choice in the time allotted) of choosing to (1) use the keystroke combination him/herself or (2) “licensing” or “selling” the keystroke combination to others in exchange for a defined payment of points. Once the inventor makes his/her choice, the game could resume. If the inventor chooses to “license” or “sell” a patented combination of keystrokes, other players could be given the option of licensing the keystroke combination for use during the rest of the game or some fraction thereof. During the game and at its end, points could be recorded for each player, individually, and a grand total calculated for all players, collectively.

The non-patent systems may take at least two forms. One uses the same game, but makes the “invention” of the keystroke combination available to all players for no payment of points (or other currency). The other makes the “invention” of the keystroke combination available to all players in return for a pre-chosen award of points equally deducted from all players.

Here is a list of steps by which the different versions of the game could proceed:

1. Provide each of X (e.g., 10) players with an identical computer screen and keyboard.

2. Make sure that all X players are available at the same time for the same period of time.

3. Show each player an introductory screen explaining the rules and goal of the game (that is, all players should try their best to score as many points as possible in the game so that they can win a prize), specifically ask each player if they have read and understand these, and condition participation in the game on an affirmative “I have read the instruction and understand them” click-through button.

4. Once all players have clicked the click-through button, the same screen appears to all players, and a timer counts down to the beginning of the game.

5. When the game begins, players use the keyboard to play the game and score points. Each player can see his/her own points in a corner of the screen.

6. Once a player discovers a pre-designated combination of keystrokes (e.g., “Q” plus the spacebar) and uses it Y number of times (e.g., 5) in a row, the game immediately stops for all players.

7. Patent version. The player who discovered the keystroke combination is presented with two clearly explained options: (1) use the keystroke combination exclusively for him/herself or (2) allow both the discovered and others to use the keystroke combination for a pre-established price (e.g., a total of Z points for the whole game or A points for each use). The player must decide between the two options within a specified period of time. If the player fails to make the choice within the time limit, a default choice is implemented (e.g., option 1). Reward version. The player who discovers the keystroke combination wins a specified amount of bonus points. A screen informs all players of the advantageous keystroke combination. All players are then allowed to use it. Null version. A screen informs all players of the advantageous keystroke combination. All players are then allowed to use it.

8. If option 2 is chosen, then all players are automatically offered the option of using the keystroke combination for the established price. If any player fails to agree affirmatively to the established price, the default can be no access to the keystroke combination.

9. The game then continues until time expires. Again, each player can see his/her scores in a corner of the screen. Those with “licenses” to the keystroke combination can use it; those without “licenses” cannot use it.

10. When time expires, the game stops. Scores are recorded for each player, and a grand total for all players is calculated. (It would be useful to be able to review scores that occurred at any point of the game.)

11. The player with the highest score receives a prize.

12. Steps 1-11 are repeated for as many groups of players as are required to provide statistically significant data.

Individual and aggregate scores for each cohort of the patent version of the game can be compared to those of the non-patent versions. Metrics to be compared include (1) time to discovery of keystroke combination (possibly an indication of the strength of incentive), (2) total aggregate score (possibly an indication of societal benefit), and (3) highest individual score of “inventor”, “licensees”, and “non-licensees” (possibly an indication of distribution of benefits within society).

The following FIGS. 1-8 show screen shots of a patent game according to another embodiment of the present invention.

Referring to FIG. 1, there is shown a screen shot of an interactive patent system (also referred to in the screen shot as a “patent game”) according to the present invention. A user may select the game type such as a patent game, a patent and open source game (in which inventions may be patented and/or made open source), a reward game, or a free use game, as described in the summary above. The user may select the total points needed to win the game, the cost of a patent, the cost of a lawyer and the number of “elements.” In one embodiment of the present invention, the elements are, for example, lettered blocks. For example, with five elements, there would be five lettered blocks, A, B, C, D and E. The combination of these lettered blocks would constitute a product. For example AB may be a product.

Other selections may be possible at this time. For example, an average patent prosecution time delay may be incorporated into the game. Similarly, an average patent litigation time delay may be incorporated into the game. Other variables may include, by are not meant to be limited to, development cost to create a new product, development time to create a new product, prior art searching time, prior art searching cost, and the like. In other words, the interactive patent system of the present invention may include variables to allow the interactive patent system to mimic real-world patent systems or patent systems with novel characteristics.

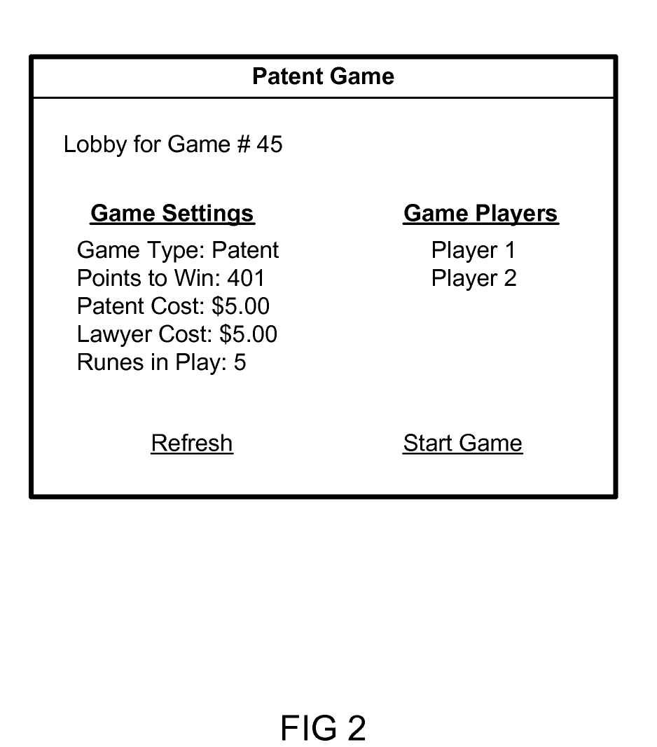

Referring to FIG. 2, there is shown a screen shot of the “lobby” as players join into a particular game. The interactive patent system of the present invention may be a multi-user system, wherein any number of users may join and participate. For example, in FIG. 2 there are two players, Player1 and Player2 in the game. The particular patent system may be given a number (such as, in this case game #45) or some other designation (e.g., “Bill and Andrew's game”), so that additional users may be directed to join that particular patent simulation session.

Optionally, once parameters are set and players are determined, the patent system may run be itself, wherein the players (competitors) may be given certain parameters based on their real-world historical actions. For example, Player1 may be the company that is running the interactive patent system, and Player1 may be configured to act according to their own corporate policies (for example, hire 3 lawyers at a certain price, always enforce patents, always patent new inventions, and the like). Player2 may be configured to act as a competitor of Player1. By allowing the patent system to automatically play out these pre-set conditions for a period of time, Player1 may be able to optimize a patent strategy and base real-world decisions on this optimized patent strategy. Such automated simulations could be run with any number of players. For example, a company that operates in a market with only four significant competitors could run a simulation with four users. Alternatively, if a company was considering acquiring a competitor, one could run a simulation that predicted how patent strategy should best adjust to the new marketplace with fewer competitors.

As a further option/embodiment, such a lobby would not appear, but instead, the Players/users would simply be those “people” of a particular virtual world. In this case, the interactive patent system would act in the background while the virtual people interacted in the virtual world.

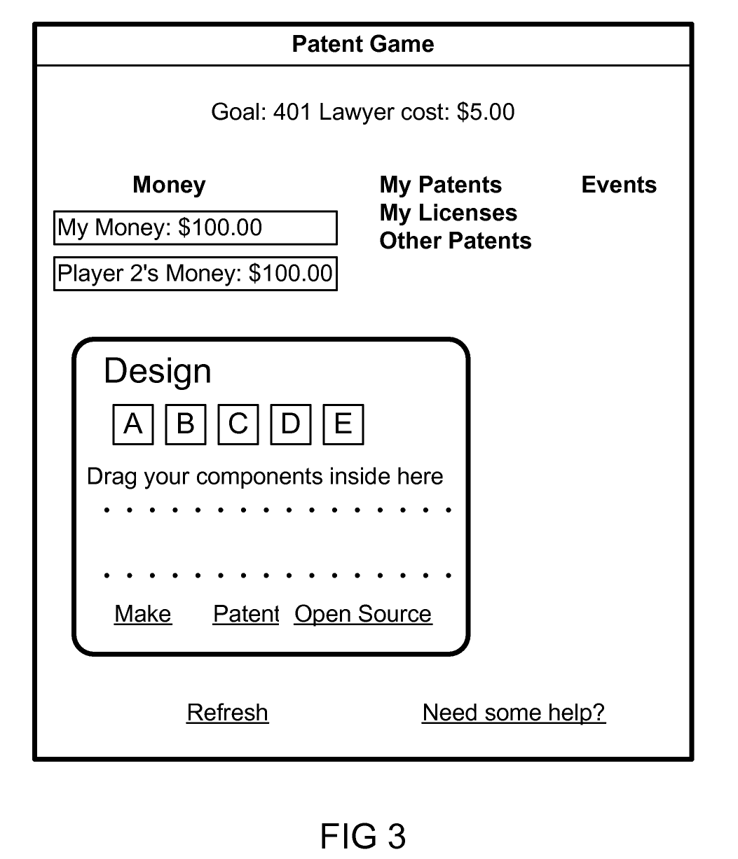

Referring to FIG. 3, there is shown a screen shot of the initial screen of the patent game. “My money” (Player1) may be shown along with the money of the other players (Player2). The Player's patent estate may be shown and the events of the game may be listed as well. To design inventions, players may use the design block to drag the elements (in this case, lettered blocks) to the design area. Once a design is decided upon (e.g., by arranging or rearranging the number and/or pattern of elements), the player can decide to make (for a possible profit) or patent (at a cost) of a product or design. Inventions could be composed of lettered blocks, non-letter symbols, shapes, colors, sounds, textures, and/or any other form of element, as a logical representation of an invention or features of the invention.

As mentioned above, the design may not be lettered blocks as shown here, but could be any designator of elements of an invention or product. Any formulation of invention based on some logical blocks or pieces will do. In different embodiments of this invention, elements could be arranged in two-dimensional, three-dimensional, or multi-dimensional patterns.

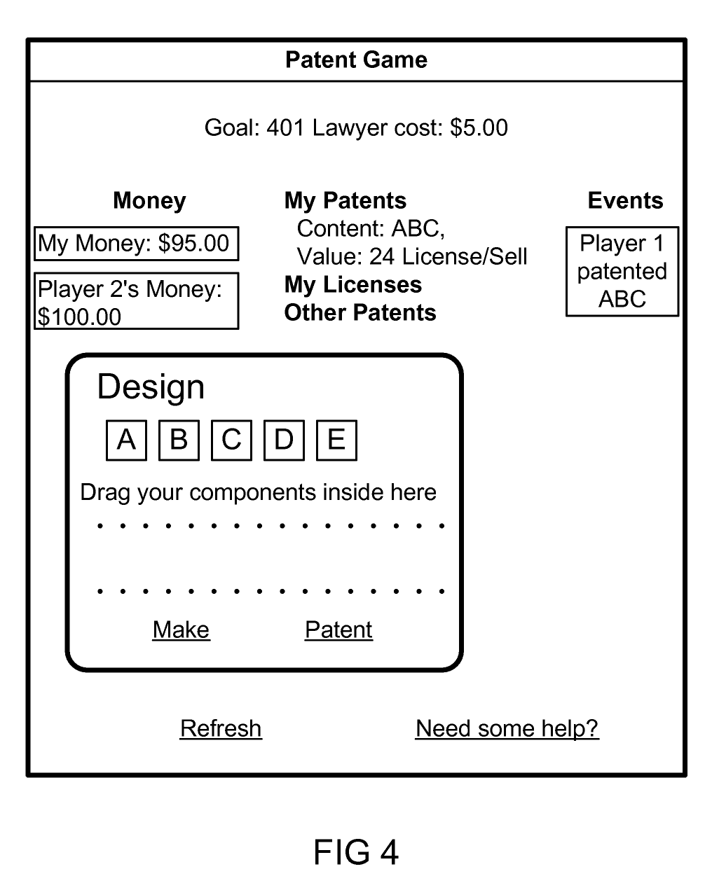

Referring now to FIG. 4, it is an example where player1 has patented the design ACB. Player1 may now offer the patent for license or sale. Should Player1 offer the patent for license or sale, Player2 may opt to license or purchase the patent from Player1. As FIG. 4 shows, when Player1 patented ACB, Player1's money was reduced $5 for creating this patent.

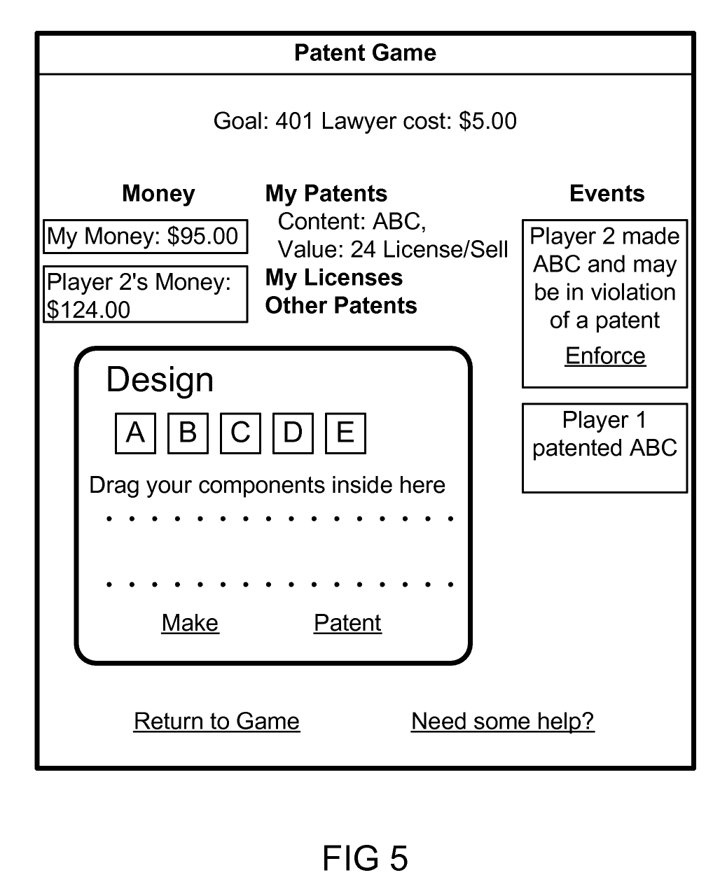

Referring to FIG. 5, there is shown a screen shot of an example where one player patents a design and a second player makes the patented design. In this case, Player1's screen may show that Player2 made the patent design and there may be an option to enforce Player1's patent.

The interactive patent system of the present invention, as shown in FIG. 5, may immediately notify Player1 that Player2 has infringed their patent by making a product patented by Player1. The patent system, however, may be programmed so that Player2 may secretly use the Player1 patented item, risking discovery and additional damages should Player1 discover the infringement.

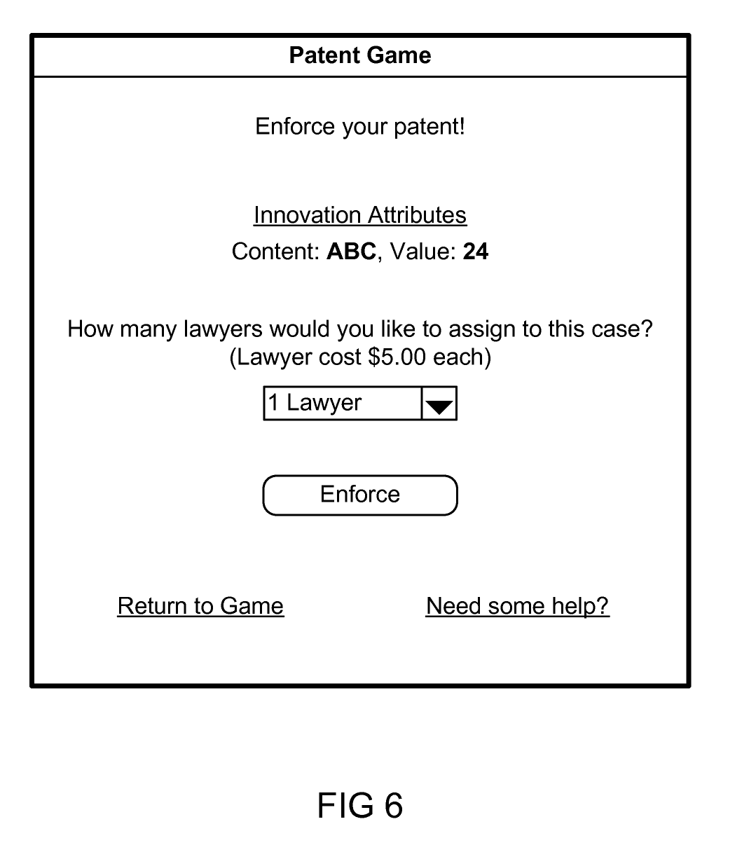

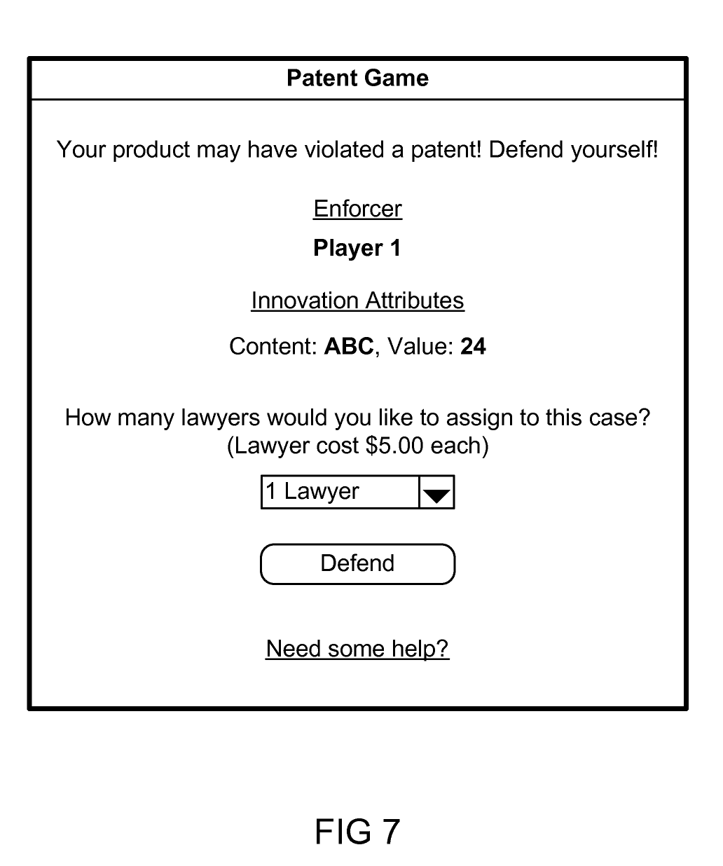

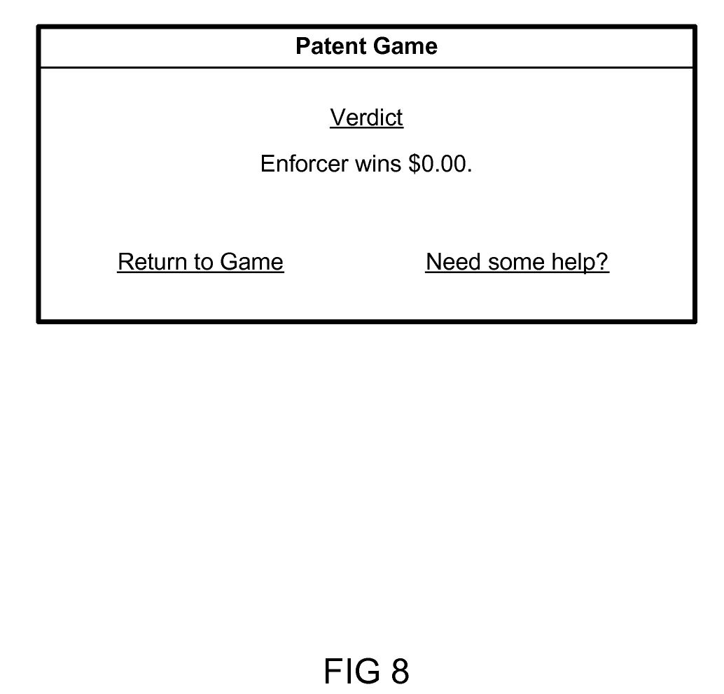

Referring to FIG. 6, should an enforcement action be commenced by Player1 against Player2, a screen may appear where the player may select how much money to spend to enforce the patent. At the same time, Player2 may also make such a selection, as shown in FIG. 7. Based on the money spent by each player, as well as a predetermined randomness factor, the winner of the enforcement action may be determined, as shown in FIG. 8.

One factor is the quality of attorneys and number of attorneys involved. Another option is to put search firms searching and discovering any infringements, for a fee, to be reported to the user. One option is to show the user directly, if there is any infringement.

The invention features or blocks, for example denoted by “ABCD” or similar notations, can have order or no-order of presentation. For example, ABCD=ABDC, in one example. Or, in another embodiment, to make the combination larger and the relationship between blocks or elements more visible, one can set that the order is important, and thus, ABCD is not the same as ABDC.

The selection can be with a drag-and-drop motion. The choices for the user are, for example, license, patent, or open source (for public domain). Other choices are to get license or sell. Messages for litigation are: won or lost. The events and messages are sometimes visible to some users, on the side of screen, based on the pre-set parameters and user's preferences. After any infringement, the user can use the enforcement option, selecting the quality and number of attorneys. The license fee is listed on screen, as well. The decisions and outcomes sometimes depend on the some random generator or semi-random seed or algorithm. Some applications force the next move, while others let the user do other selection and ignore/delay the next move or window.

For any derivatives of an open source, e.g. “ABC”, one may be able to get a patent, if it has a new feature added to it, but the subset of the original idea would probably be not patentable anymore, unless there is an unexpected result or synergy somewhere.

The expiration date is shown by a clock/calendar on screen, which also affects the value of patent, as decreasing versus time. The value of the patent can also be variable depending on the market, e.g. demand and supply ratio, or offers/auctions. Some of the choices are: common, no-open-source, or both-patent-and-open-source. In Admin option, one can change the fundamental, basic, or boundary parameters.

The parameters for the game can be set before, and stored, with a file name, to be recalled later, for specific game and corresponding pre-set parameters. The unit for scores is dollar, point, or any other real or virtual counting system. The bank account may have negative balance, which can become positive again by adding the funds. Or, one can put a min. limit of zero balance on it.

The interactive patent system described above with reference to FIGS. 1-8 may be developed with software systems known to one skilled in the art. For example, Ruby on Rails (“Ruby”) may be used to develop the interactive patent system of FIGS. 1-8. Ruby is a web-application and persistence framework that includes everything needed to create database-backed web-applications according to the Model-View-Control pattern of separation (as an example). This pattern splits the view (also called the presentation) into “dumb” templates that are primarily responsible for inserting pre-built data in between HTML tags. The model contains the “smart” domain objects (such as Account, Product, Person, Post) that holds all the business logic and knows how to persist themselves to a database. The controller handles the incoming requests (such as Save New Account, Update Product, Show Post) by manipulating the model and directing data to the view.

In Ruby, for example, the model is handled by what's called an object-relational mapping layer entitled Active Record. This layer allows you to present the data from database rows as objects and embellish these data objects with business logic methods. The controller and view are handled by the Action Pack, which handles both layers by its two parts: Action View and Action Controller. These two layers are bundled in a single package due to their heavy interdependence. This is unlike the relationship between the Active Record and Action Pack that is much more separate. Each of these packages can be used independently outside of Ruby, as an example.

By default, Ruby will try to use Mongrel and lighttpd web servers if they are installed. Otherwise, Ruby will use the WEBrick, the webserver that ships with Ruby. When you run script/server, Ruby will check if Mongrel exists, then lighttpd and finally fall back to WEBrick. This ensures that you can always get up and running quickly. Mongrel is a Ruby-based webserver with a C-component (which requires compilation) that is suitable for development and deployment of Ruby applications. If Mongrel is not installed, Ruby will look for lighttpd. It is considerably faster than Mongrel and WEBrick and also suited for production use, but requires additional installation and currently only works well on OS X/Unix, as an example. And finally, if neither Mongrel nor lighttpd are installed, Ruby will use the built-in Ruby web server, WEBrick. WEBrick is a small Ruby web server suitable for development, but not for production.

It is also possible to run Ruby on any platform that supports FCGI. Apache, LiteSpeed, IIS are just a few. More information on FCGI may be found at http://wiki.rubyonrails.com/rails/pages/FastCGI, as an example.

The Ruby on Rails code used to create the interactive patent system used in FIGS. 1-8 is included as a computer program listing appendix on CD accompanying this application. This code is meant as one example of possible code that may be used to carry out the present invention; Other systems could be written in other languages or using other frameworks. Each section of code begins with #<filepath>, wherein <filepath> describes the file hierarchy in which the code may exist. If the particular <filepath> is empty, a second entry marked #directory empty” will be present in the code. These comments are meant to permit a user to recreate not only the code, but also the specific file and folder hierarchy used for the example shown in FIGS. 1-8.

While the above description describes a graphical, computer-based game, the game may be created to operate as a text-based game as well. Such a text-based game may be useful when a player is available only on, for example, email or text messaging. Similarly, the game could be adapted for use with sound prompts and vocal commands (e.g., for visually impaired users or users without access to a computer screen or the like).

As noted above, not only could money (or points) be a factor in the interactive patent system of the present invention, but time may also be considered a factor. The exchange currency is another option for more realistic costs and fees for different jurisdictions around the world. Time delays may be incorporated for patent prosecution, freedom to operate determinations, product design, and patent enforcement. These time delays may be particularly useful when the interactive patent system of the present invention is incorporated into a virtual world. Time can also be a factor that measures skill of the user because some users may be able to complete tasks in the patent simulation more quickly than others, thus gaining a competitive advantage in accumulating points (or money, or whatever is used to represent scoring in a particular simulation).

Here is a description of the administrative interface and its key features. The administrative interface for the patent game allows users to trace and analyze the course of a given game. At the simplest level, it offers users a quick and easy way to view and query the data stored in the database for a set of games. The interface can display, for any given game, the game type, the players involved in the game, what innovations were available to the players, what patents were filed, what licenses were granted, and what critical events took place during the game.

The events portion of the interface is particularly useful for users trying to follow the course of a game. When put together in chronological order, the collection of events for a given game forms a rough narrative describing the players' interactions. An event might be something like, “Player A patented ‘ABC’,” or, “Player B licensed ‘ABC’.” All interactions that affect the state of the game are logged as a single-sentence event in the database, and maybe displayed to all or some users.

The quantitative information stored in the database, such as the number of patents and licenses created during a game, allows users to perform statistical and numerical analyzes on the data. This is helpful for users wanting to answer questions like, “What game mode stimulates the in-game economy the most?”

One application of the invention: One of the enduring and important issues in patent law is whether or not the incentives provided by patent protection benefit society more than would alternative systems. Underlying the patent system is a key hypothesis (and hope): inventive activity will be spurred by the prospect of patent protection, leading to the accrual of greater societal benefits than would be possible by alternative, non-patent systems. One way to test this hypothesis is experimentally to simulate the behavior of inventors and society under conditions approximating patent and non-patent systems. Then, by measuring differences in a metric representing societal benefit, it should be possible to make direct quantitative comparisons between alternative systems. Another question is fee structures for big and small entities, to be fair to all, which can be tested as well, using our simulation.

This can be used for legal systems, patent, any IPs, tangible IPs, trademarks (for example), or rules. The rules, parameters, or invention features can be edited, modified, increased, or decreased. A (relational) database and statistical module can study the behavior of the users or record various actions.

While the above describes a patent game that may be played by multiple players via, for example, the internet, the present invention should not be limited to such a particular scope. The interactive patent system of the present invention, as discussed above, may be used not only as a patent game, but also as a business strategy tool, a training tool and the like. Furthermore, the patent simulation described herein could also be implemented on a single computer or on a group of networked computers not part of the internet. It can be connected to PDAs and cell/smart phones/tablets/processors. It can have different user-interface, e.g. 3D presentation, walking or talking avatars, artificial intelligence, or neural networks, for learning or training purposes, from the past results.

While the above description describes an interactive patent system, the present invention may be useful not only in patent systems, but any complex legal system, particularly intellectual property systems. For example, the present invention may be useful for providing an interactive copyright or trademark system. For example, the practices, rules, regulations, statutory provisions, and constitutional provisions of copyright, trademark, plant variety protection, computer chip design protection, boat hull design, or any other intellectual property system could be simulated by the invention disclosed herein. For example, a copyright simulation might allow users to generate protectable text strings, images, music, or video that could be sold for points (or money), such content could be registered as copyrighted, licensed, sold, infringed, and enforced in an analogous manner to the patent simulation. Moreover, a trademark simulation might allow users to generate protectable words and phrases that may be associated with certain products (e.g., products patented during the game). Thus, it can apply to all IPs, such as trade secrets, and it can apply to all methods of transactions, such as cash, reverse-auctions, and open-auction. It can apply to all contents, e.g. digital data or music.

It should be understood, of course, that the foregoing relates to preferred embodiments of the invention and that modifications may be made without departing from the spirit and scope of the invention as set forth in the following claims. For example, the system could integrate real and virtual invention systems together to create hybrid real/simulated systems. Additionally the game could be designed to alter the rules of the patent system dynamically to maximize net worth or influence other factors. The system could also be designed to apply different rules to different players. The system could also be used to visualize how some intellectual property interaction appeared to one or more of the parties involved. For example, it can be tailored for a risk-taking individual or more conservative person, with adjustable parameters by administrator or the user(s). One person may have more adjustment capabilities than other users, similar to veto power, in case of conflict or difference of opinion/choices.

Any other variations of the teachings above are intended to be covered and protected by the current application.

1. A system for simulating or operating an intellectual property environment, said system comprising:
an administrator module;
a rules module; and
a user interface;
wherein said administrator module sets rules for said rules module either before and/or during the operation of the environment;
wherein a user interfaces with said system through said user interface;
wherein said user puts together an invention object, using two or more invention elements from an invention repository or some other source;
wherein said user has an option to manufacture said invention object in said intellectual property environment; and
wherein said user has an option to apply for a patent or other protection for said invention object in said intellectual property environment.

2. A system as recited in claim 1, wherein said system further comprises an accounting module.

3. A system as recited in claim 1, wherein said system is incorporated in a training or research module for students or analysts.

4. A system as recited in claim 1, wherein said system handles multiple users.

5. A system as recited in claim 1, wherein said system analyzes and records statistics and behavior of a person, a group of people, or society.

6. A system as recited in claim 1, wherein said system further comprises an infringement determination module.

7. A system as recited in claim 1, wherein said system further comprises an enforcement module.

8. A system as recited in claim 1, wherein said system further comprises a template module, to store format and parameters related to a specific simulation.

9. A system as recited in claim 1, wherein said user sells a patent.

10. A system as recited in claim 1, wherein said user licenses a patent.

11. A system as recited in claim 1, wherein said system displays history of actions and decisions.

12. A system as recited in claim 1, wherein said user auctions a patent.

13. A system as recited in claim 1, wherein said user presents a patent for a patent pool.

14. A system as recited in claim 1, wherein said user cross-licenses a patent.

15. A system as recited in claim 1, wherein said two or more invention elements have a logical order with respect to each other.

16. A system as recited in claim 1, wherein said two or more invention elements have no logical order with respect to each other.

17. A system as recited in claim 1, wherein said system further comprises a clock and a calendar, to keep track of time and to time-stamp actions and events.

18. A system as recited in claim 1, wherein said system keeps track of an expiration date of a patent.

19. A system as recited in claim 1, wherein said system is incorporated in a virtual world, a simulation game, or a real-world legal system.

20. A system as recited in claim 1, wherein said system permits said user to carry one bank account from one simulation session to another.
